(19) United States
(12) Patent Application Publication
(10) Pub. No.: US 2021/0209708 A1
(43) Pub. Date: Jul. 8, 2021

(54) MULTI-POLICY PROCESSING OF A DOCUMENT

(71) Applicant: Legalogic LTD., Tel Aviv (IL)

(72) Inventor: Ilan ADMON, Tel Aviv (IL)

(21) Appl. No.: 16/736,257

(22) Filed: Jan. 7, 2020

(51) Int. Cl. G06Q 50/18; G06F 16/93

(52) U.S. Cl. CPC G06Q 50/188; G06F 16/93

(57) ABSTRACT

A method, system and product for multi-policy processing of a document, including obtaining a first policy comprising a first set of rules from a first edge device; obtaining a second policy comprising a second set of rules from a second edge device; obtaining a document comprising conditions; processing the first set of rules on the document to classify each condition in the document as allowed or not allowed by the first policy; processing the second set of rules on the document to classify each condition in the document as allowed or not allowed by the second policy; and providing an output that identifies conditions in the document that are not allowed by one of the first and second policies. The output is provided without disclosing a content of the first policy to the second edge device and without disclosing a content of the second policy to the first edge device.

### TECHNICAL FIELD

The present disclosure relates to executing policies in general, and to systems, products, and methods for determining conditions of a document under negotiation by executing policies, in particular.

### BACKGROUND

Traditional methods of negotiation typically involve face-to-face meetings, telephone calls, electronic mails (e-mails), faxes, or the like. Such negotiations may be iterative and are typically time and effort consuming.

Additionally, reviewing terms of a plurality of paperwork to determine whether or not the terms are acceptable, may be time and effort consuming. Manual review of each document may require substantive expertise, such as of expert lawyers. Such human experts may not necessarily be available, and may be associated with a high cost. Additionally, manual review may also be subject to human error.

### BRIEF SUMMARY

One exemplary embodiment of the disclosed subject matter is a method comprising: obtaining a first policy from a first edge device, wherein the first policy comprises a first set of one or more rules regarding a first set of one or more conditions, respectively; obtaining a second policy from a second edge device, wherein the second policy comprises a second set of one or more rules regarding a second set of one or more conditions, respectively; obtaining a document comprising one or more conditions; processing the first set of one or more rules on the document to classify each condition of the one or more conditions in the document as allowed or not allowed by the first policy; processing the second set of one or more rules on the document to classify each condition of the one or more conditions in the document as allowed or not allowed by the second policy; and providing an output that identifies conditions of the one or more conditions in the document that are not allowed by at least one of the first and second policies, wherein the output is provided without disclosing a content of the first policy to the second edge device and without disclosing a content of the second policy to the first edge device.

Optionally, the method comprises providing the output by providing an update for the document, wherein the update comprises a modification of at least one condition of the document that is not allowed by the first policy or by the second policy to comply with the first or second sets of one or more rules.

Optionally, the method comprises updating the document to provide the updated document, and providing the updated document to the first and second edge devices.

Optionally, the method comprises determining that a condition indicated as a preferable by a rule of the first or second sets of one or more rules and not indicated as excluded by a rule of the second or first sets of one or more rules, respectively, is missing in the document; and wherein the updating comprises adding the condition to the document, whereby the updated document comprises the condition.

Optionally, the method comprises comparing the one or more conditions of the document to a database to determine a normalized representation of the one or more conditions, wherein the database comprises a normalized representations of conditions, each of which comprises a boilerplate wording used in documents to manifest the respective condition, and processing the first and second sets of one or more rules on the normalized representation of the one or more conditions.

Optionally, the first policy defines priorities with respect to at least a portion of the first set of one or more rules; the second policy defines priorities with respect to at least a portion of the second set of one or more rules; and the modifying is performed based on a balance between the priorities defined by the first and second policies.

Optionally, the balance is a local balance; the first policy defines a first priority for a first rule; the second policy defines a second priority for a second rule; the modifying comprises selecting a parameter for an intersection range between the first rule and the second rule, wherein the selecting comprises: determining that the first priority is a higher priority than the second priority; and biasing the selection of the parameter to favor the first rule.

Optionally, the balance is a power balance, the document is a legal document setting conditions between a first entity and a second entity, the first policy is a policy of the first entity, the second policy is a policy of the second entity; wherein the method comprises: determining an estimated relative power of the first entity and of the second entity, whereby determining that the estimated relative power of the first entity is greater than the estimated relative power of the second entity; wherein the modifying comprises: selecting a parameter for an intersection range between a first rule of the first policy and between a second rule of the second policy, wherein the selection of the parameter is biased to favor the first rule, whereby biasing the selection to favor an entity having a greater estimated power.

Optionally, the first rule of the first policy comprises a first range of parameters for a condition of the document, and the second rule of the second policy comprises a second range of parameters for the condition of the document; wherein the first range and the second range overlap at the intersection range; wherein the selecting the parameter comprises: identifying a highest-utility parameter in the intersection range, wherein the highest-utility parameter is a parameter having a highest utility for the first entity in the intersection range; and selecting the highest-utility parameter.

Optionally, the modifying comprises performing one or more selections of parameters with respect to a first set of one or more intersection ranges between the first policy and the second policy that favors the first policy; performing one or more selections of parameters with respect to a second set of one or more intersection ranges between the first policy and the second policy that favors the second policy; and wherein a ratio between the first set and the second set is based on the balance.

Optionally, the balance is an overall equal balance, wherein the ratio is about 1:1.

Optionally, the balance is a random balance, wherein the ratio is determined randomly.

Optionally, an intersection range of a rule of the first policy is prioritized in an opposite order than an intersection range of a corresponding rule of the second policy.

Optionally, the method comprises randomly selecting parameters for intersection ranged between first rules of the first policy and between second rules of the second policy, respectively.

Optionally, the method comprises determining that a first range and a second range are disjoint, wherein the first range is defined by a first rule of the first policy with respect to a condition, wherein the second range is defined by a second rule of the second policy with respect to the condition, wherein the document comprises the condition; and providing a notification that automated resolution cannot be performed with respect to the condition.

Optionally, the method comprises accumulating a plurality of policies of an entity, and the plurality of policies comprise the first policy and exclude the second policy; analyzing the plurality of policies to determine a consistency rate of policies of the entity; and in response to determining that the consistency rate is below a threshold, preforming a remedial action

Optionally, the method comprises obtaining a training set, wherein the training set comprises a sequence of policies of an entity, and a label indicating whether the entity is malicious; training a predictor to identify a malicious entity using the training set; obtaining a sequence of past policies of a first entity that provided the first policy; applying the predictor to determine whether the first entity is malicious; and in response to a determination that the first entity is malicious, performing a remedial action to prevent malicious activity of the first entity

Optionally, the method comprises processing the first policy on the document at the first edge device to determine whether or not the document complies with the first set of one or more conditions.

Optionally, the method comprises processing the second policy on the document at the second edge device to determine whether or not the document complies with the second set of one or more conditions.

Optionally, the method comprises obtaining the first policy, the second policy, and the document is at a cloud server.

Another exemplary embodiment of the disclosed subject matter is computer program product comprising a non-transitory computer readable storage medium retaining program instructions, which program instructions when read by a processor, cause the processor to perform the steps of: obtaining a first policy from a first edge device, wherein the first policy comprises a first set of one or more rules regarding a first set of one or more conditions, respectively; obtaining a second policy from a second edge device, wherein the second policy comprises a second set of one or more rules regarding a second set of one or more conditions, respectively; obtaining a document comprising one or more conditions; processing the first set of one or more rules on the document to classify each condition of the one or more conditions in the document as allowed or not allowed by the first policy; processing the second set of one or more rules on the document to classify each condition of the one or more conditions in the document as allowed or not allowed by the second policy; and providing an output that identifies conditions of the one or more conditions in the document that are not allowed by at least one of the first and second policies, wherein the output is provided without disclosing a content of the first policy to the second edge device and without disclosing a content of the second policy to the first edge device.

Yet another exemplary embodiment of the disclosed subject matter is a system comprising a processor and coupled memory, the processor being adapted to perform: obtaining a first policy from a first edge device, wherein the first policy comprises a first set of one or more rules regarding a first set of one or more conditions, respectively; obtaining a second policy from a second edge device, wherein the second policy comprises a second set of one or more rules regarding a second set of one or more conditions, respectively; obtaining a document comprising one or more conditions; processing the first set of one or more rules on the document to classify each condition of the one or more conditions in the document as allowed or not allowed by the first policy; processing the second set of one or more rules on the document to classify each condition of the one or more conditions in the document as allowed or not allowed by the second policy; and providing an output that identifies conditions of the one or more conditions in the document that are not allowed by at least one of the first and second policies, wherein the output is provided without disclosing a content of the first policy to the second edge device and without disclosing a content of the second policy to the first edge device.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of an exemplary environment in which the disclosed subject matter may be utilized, in accordance with some exemplary embodiments of the disclosed subject matter;

FIG. 2 illustrates a flowchart diagram of a method, in accordance with some exemplary embodiments of the disclosed subject matter;

FIG. 3 illustrates a flowchart diagram of a method, in accordance with some exemplary embodiments of the disclosed subject matter; and

FIG. 4 illustrates a block diagram of an apparatus, in accordance with some exemplary embodiments of the disclosed subject matter.

### DETAILED DESCRIPTION

One technical problem dealt with by the disclosed subject matter is to automate a negotiation process between two parties, or more. In some cases, negotiations may involve a document whose content needs to be negotiated between parties. An example of such a document may be a contract or any legal instrument where two or more parties attempt to come to terms with each other. For example, during a typical negotiation, one party may make an offer and then wait for the other party to either accept or object to at least one condition, term, or element of the offer. This process may go on with further iterations for each of the elements that is to be agreed upon before a final contract is formed. The negotiation may be terminated when final agreement of both parties to the terms of the contract is reached. However, by the time all the revisions are completed, the negotiation may take too long. For example, negotiations may take hours, days or even years. In today's quickly-evolving world, such time frames for a single negotiation may be unrealistically slow and time consuming. In addition, the cost of manually handling negotiations may be high, e.g., since the negotiations may be time consuming and may require substantial involvement by a human expert, such as a lawyer, a businessman, or the like.

Another technical problem dealt with by the disclosed subject matter is automatically negotiating terms of a contract between a plurality of parties such as business entities, private entities, or the like, which may have opposite interests. In some cases, interests of negotiating parties regarding terms of a contract may have an inverse correlation. For example, an employer negotiating an employment contract of an employee may have opposite interests than his employee, as the employee may aim for receiving a high salary while the employer may aim for providing a low salary. Additionally, it may be difficult to automate such a negotiation since each party may require to keep its potential bargaining range confidential with respect to the other party. For example, an employer negotiating an employment contract may wish keep his maximal salary offer unknown to his employee, so that the employee may accept a lower offer. A naive solution may include transferring a traditional negotiation to an electronic platform, enabling more efficient person-to-person communication channel, but such naive solution does not decrease any negotiation iterations and is nevertheless time and effort consuming.

Yet another technical problem dealt with by the disclosed subject matter is negotiating terms of a contract while keeping a policy of each participant private and secure with regard to the other participants. In some cases, it may be desirable that a first party will be informed of preferences of a second party regarding one or more terms, for example, while keeping a potential bargaining range of the second party confidential. Specifically, it may be advantageous for the second party, that the first party will not have a direct access to one or more limitations and rules of the second Pte.

One technical solution of the disclosed subject matter is eliminating a need to negotiate terms of a contract by receiving from each participant a policy including rules indicating the participant's preferences regarding terms of contracts. In some exemplary embodiments, a contract formation method may be implemented to determine an automated resolution for a document that is under negotiation in a remote server such as a cloud server, for example, based on policies of each participant. In some exemplary embodiments, a first party to a negotiation may send or provide access to his policy rules to a cloud server, and a second party to the negotiation may send or provide access to her policy rules to the cloud server. Additionally, a document under negotiation may be sent or made accessible to the cloud server. Both policies may be obtained in a formal form, such as defined using a formal language. Additionally, or alternatively, the policies may be provided to an executable program configured to interpret and implement the instructions provided therein. Additionally, or alternatively, the policies may be provided as an executable program, such may be obtained by compiling the formal language into an executable, binary form. In some cases, processing the policy on the document may enable to adjust terms in the document while aiming to find acceptable terms for both parties. If no acceptable terms are found for an element in the document, the element may be returned for manual negotiation between the first and second parties.

In other exemplary embodiments, instead of implementing the contract formation method at a remote server, the contract formation method may be implemented at one or more edge devices while ensuring privacy to both parties. In this case, no server may be required to implement the contract formation method. In some cases, the first party to the negotiation may retain his policy at a first edge device, and a second party to the negotiation may retain her policy at a second edge device. Additionally, a document under negotiation may be accessible to at least one of the edge devices. In some exemplary embodiments, an edge device may process one or more policies in a privacy-preserving computation such as a secure Multi-Party Computation (MPC) scheme or any other cryptography-based scheme, e.g., to determine the final document that is in line with both policies. In some cases, privacy-preserving computations may enable distributed parties to jointly compute an implementation of a policy rule on a document without revealing their own private policy rules. Such computation may adjust terms in the document without providing direct access to each other's policy. If no acceptable terms are found for an element in the document, the element may be returned for negotiation between the first and second parties.

In some exemplary embodiments, a contract formation method may comprise obtaining a policy, an executable form of the policy, or the like. The policy may include a set of one or more rules regarding a set of one or more conditions, respectively. In some exemplary embodiments, the set of one or more rules may be converted to an executable form such as an executable program, an executable software, executable instruction, or the like. Additionally, or alternatively, the set of one or more rules may be executed using another executable that is configured to receive the rules as input and process a document according thereto. In some cases, applying the policy on a document may result in an indication of one or more allowed conditions of the document, an indication of one or more forbidden conditions of the document, an indication of one or more necessary conditions of the document, an indication of one or more allowed ranges of conditions of the document, an indication of one or more forbidden ranges of conditions of the document, an indication of one or more modification suggestions, an indication of one or more markups, an indication of one or more priorities of the conditions, an indication of one or more conditions to be excluded, or the like. In some exemplary embodiments, a “condition” may refer to one or more elements of the document, one or more parameters in an element of the document, one or more ranges of the parameters, one or more phrases of the document, one or more terms of the document, or the like.

In some exemplary embodiments, the contract formation method may comprise obtaining a first policy from a first edge device and a second policy from a second edge device. In some exemplary embodiments, the first policy may comprise a first set of rules regarding a first set of conditions, respectively. The second policy may comprise a second set of rules regarding a second set of conditions, respectively. In some exemplary embodiments, the first and second sets of rules may relate to a same set of conditions, to different sets of conditions that may or may not be at least partially disjoint, or the like.

In some exemplary embodiments, the contract formation method may comprise obtaining a document that includes one or more conditions. In some exemplary embodiments, the term “document”, as used herein, may refer to a contract, a legal agreement, terms of use, or the like. The document may be provided in natural language, in a free-text non-structured manner, in a formal language, in a structured manner, or the like. In some exemplary embodiments, the document may include a legal instrument such as a contract whose content needs to be agreed upon both parties. In some cases, the document may be obtained from an edge device, a server, or the like.

In some cases, the contract formation method may be implemented at a trusted server, e.g., thus obtaining the first policy, the second policy, and the document at the server. In some cases, for example, when implementing a secure MPC protocol or a two-party computation (2PC) protocol, the contract formation method may be implemented without a server, e.g., at one or more edge devices. In other cases, a secure MPC and 2PC protocols may be implemented in any other way. In some exemplary embodiments, implementing the MPC protocol or the 2PC protocol may include masking or encrypting at each edge device portions of one or more rules of a policy of the edge device, e.g., as polynomial points, and sharing the encrypted portions with at least one other edge device. For example, an allowed range of values for a condition may be converted to polynomial points and split into any number of shares that may be distributed. Depending on the type of scheme used, the original range values can be reconstructed only by knowing all or a predefined number of these shares. In some cases, rules of a policy that do not involve parameters, ranges of parameters, continuous parameters, or the like, may be shared without using secure computation protocols. In some exemplary embodiments, each edge device may identify the rules from its respective policy that are relevant and applicable on the given document, such as by ignoring rules for terms that do not appear in the document, conditional rules who are irrelevant due to their conditions and the content of the document, or the like. In some exemplary embodiments, only the relevant rules may be encrypted, thus providing for an encrypted policy that is applicable to the target document, and which may not be applicable to other documents. According to this scenario, the document may be accessible to all edge devices and a distributed calculation may provide an updated document according to all the distributed portions of policy rules. In other cases, an execution of a policy may be performed at an edge device of the opposite party, e.g., without revealing the rules of the policy to the opposite party. For example, an executable version of a policy may be provided to the opposite party. As another example, an encrypted function may be provided to the opposite party, who may apply it together with a function created based on the local policy of such opposite party. In some cases, the document may be produced or obtained from any source or device, including but not limited to the first edge device, the second edge device, the cloud server, or the like.

In some exemplary embodiments, the contract formation method may include applying and processing the first set of one or more rules on the document, for example, to classify each condition in the document as allowed or not allowed by the first policy. In some exemplary embodiments, processing the first set of one or more rules on the document may generate modification suggestions for the document. Similarly, the contract formation method may include processing the second set of one or more rules on the document, for example, to classify each condition of the one or more conditions in the document as allowed or not allowed by the second policy. In some exemplary embodiments, the first and second sets of one or more rules may be applied on the document in parallel or subsequently.

In some exemplary embodiments, a policy, when applied on a document, may provide an analysis as to what should be done in a given document. Possible results of an application of a policy may include a suggested text amendment, a suggested range amendment, markups of areas of the document that contradict the policy, or the like. In some exemplary embodiments, applying the policy on the document may result in an identification of locations in the document that violate the policy.

In some exemplary embodiments, the contract formation method may include providing an output based on applying the first or second policies on the document. In some exemplary embodiments, the output may identify conditions in the document that are not allowed by the first or second policies. In some cases, the output may identify the conditions visually, aurally, or the like, for example, by highlighting the problematic conditions.

In some exemplary embodiments, the output may include one or more suggested amendments to the conditions that are not allowed, e.g., in the form of notes, highlighted text, or the like. In some exemplary embodiments, the suggested amendments may be configured to replace conditions that are not allowed to conditions that are.

In some exemplary embodiments, the output may include an update for the document, thus providing an updated document. In some exemplary embodiments, the update may include a modification of at least one condition of the document that is not allowed by the first policy or by the second policy that causes the condition to comply with the first or second sets of one or more rules. For example, if a condition in the document is allowed by the first policy but not by the second policy, the condition may be modified to include a suggested modification that complies with both policies. In some cases, if no suggested modification complies with both policies, alternative suggestions may be produced based on one or more other sources, databases, or the like.

In some exemplary embodiments, the document may be updated based on the first and second policies, without disclosing a content of the first policy to the second edge device and without disclosing a content of the second policy to the first edge device. In some cases, the document may be updated at a server that is configured to obtain both the first and second policies from corresponding policy owners without disclosing their content to the other policy owner. In other cases, the document may be updated at any location or device, for example, at the first and second edge devices which may utilize a secure MPC scheme to enable the parties to keep their policies private from each other while allowing application of both policies on the document. In other cases, any other technology or scheme may be implemented to keep the content of the policies confidential, compartmentalized, or the like, so as to protect the participants' privacy from each other while allowing an execution of an executable form of both policies on the document.

In some exemplary embodiments, the updated document may be provided to the first and second edge devices. In some cases, the updated document may be provided to any other device such as a server, a user device, a cloud node, or the like. In other cases, the content of the updated document may be confidential and only direct participants may receive access to the updated document. For example, the updated document may be protected with a password, and only the negotiating parties may receive a password.

In some exemplary embodiments, a plurality of policies of an entity, a policy owner, or the like, may be accumulated over time. The plurality of policies may be stored and analyzed to determine a consistency rate of the entity or policy owner. In some cases, the plurality of policies may include the first policy, or any other policy created for the policy owner, but exclude the second policy or any other policy created for a different entity. In some exemplary embodiments, the consistency rate may indicate how similar the different policies of the policy owner were, how many different policies of the policy owner were detected per time frame, or the like. In some exemplary embodiments, the sequence of policies provided by the same policy owner may indicate whether the policy owner is attempting to rig the system, such as by modifying acceptable ranges to attempt to reverse engineer the policy of the opposing party. In some exemplary embodiments, a classifier may be trained to determine based on the sequence of policies whether the policy owner has malicious intent in providing the policies. In some exemplary embodiments, the consistency rate may be compared to a threshold, and in response to determining that the consistency rate is below a threshold, a remedial action may be performed. As an example, a sequence of policies in which a single parameter is consistently decreased by a constant ratio or value, such as value of 65, followed by the value 60, followed by the value 55, and so on, may trigger a remedial action. It is noted that the disclosed subject matter is not limited to constant values, and other methods may be employed. As an illustrative example, regression analysis may be performed to identify a trend indicative of an attempt to game the system.

In some exemplary embodiments, a training set for classifying policy owners as malicious or not, may be obtained. In some exemplary embodiments, the training set may comprise a plurality of policies from different policy owners accumulated over time. The training set may comprise, for each entity, a sequence of policies of the entity, and a label indicating whether the entity was found to be malicious. In some exemplary embodiments, a predictor may be trained to identify a malicious entity using the training set. The sequence of policies may be stored and analyzed to determine for each entity a corresponding consistency rate, for example, using a machine learning classifier, using an Artificial Neural Network (ANN), using a clustering module, using a classification algorithm, or the like. In some cases, a sequence of past policies of a first entity that provided the first policy may be obtained. The predictor may be applied to the past policies of the first entity to determine or estimate whether or not the first entity is malicious.

In some exemplary embodiments, upon determining that a consistency rate of a first entity is below a threshold, the first entity may be determined to be malicious. Additionally or alternatively, the entity may be determined to be malicious based on other features or indications. In response to a determination that the first entity is malicious, a corresponding remedial action may be determined, implemented, or the like, for example, to prevent malicious activity of the first entity. For example, a remedial action may include sending an alert to associated parties, sending a notification, blocking the first entity from participating in automated document negotiations, permanently or for a predetermined time duration, blocking the first entity from having access to a server or a software program that implements the contract formation method, or the like.

In some exemplary embodiments, the first edge device may include a policy executer configured to convert the first policy to an executable form and process the executable form on the document. In some exemplary embodiments, the first policy may be processed on the document at the first edge device, e.g., to determine whether or not the document complies with the first set of one or more conditions. This may enable an owner of the first policy to determine whether or not the document complies with the first set of one or more rules and to view suggested amendments. In some exemplary embodiments, the second policy may be processed on the document in a similar manner. Additionally, or alternatively, the policy executer may be configured to receive the policy, defined using a formal language, to review the policy and analyze a document based on the policy. The policy executor may serve as a policy interpreter instead of or in addition to operating as a policy complier that generates an executable policy.

One technical effect of utilizing the disclosed subject matter is providing an automated negotiation process that does not involve iterations. In some exemplary embodiments, human involvement in negotiation processes may be reduced. In some exemplary embodiments, utilization of policies may enhance time usage and efficiency of negotiation processes while eliminate a need to have iterative negotiations between the parties. In some cases, the only input or requirement from the user is to indicate his rules, preferences, limits, or the like, that may be reused in future executions. In other cases, no direct input is required and rules, preferences, limits, or the like, of the user may be determined automatically, for example, based on previous recorded actions and information associated with the user. For example, a user may supply approved documents that may be used to generate his preferred rules. In another example, an Internet site such as a Gmail™ account of a user may accumulate data about the user and create a profile of the user indicating his preferred rules based thereon.

Another technical effect of utilizing the disclosed subject matter is automatically providing a document with terms that are agreed upon by both associated parties without any physical or virtual iterative negotiation between the parties. In some cases, when utilizing the disclosed subject matter, a policy owner may receive a final version of a contract that complies with his policy and with the other participant's policy without being required to ever view the contract previously. A contract formation method according to the disclosed subject matter may produce terms that are agreed upon in a matter of seconds, milliseconds, or the like, by merely utilizing mathematical calculations. In some exemplary embodiments, this may reduce the number of iterations and reduce efforts for both sides.

Yet another technical effect of utilizing the disclosed subject matter is providing a secure and confidential contract formation process that takes into account the participants' policies while strictly keeping the privacy of each participant. Specifically, no participant may have access to rules of a policy of a different participant.

Yet another technical effect of utilizing the disclosed subject matter is providing a manner to identify malicious activity attempting to obtain access to confidential information while negotiating a plurality of different documents. For example, a case where a policy owner attempts to identify the range of the opposite party may be identified. In such a case, the policy owner may start off with an initial range, and observe the outcome of the negotiations. In following negotiations, the range for the same parameter may be modified repeatedly in an attempt to identify the low bound set by the opposite party, the high bound set by the opposite party, a combination thereof, or the like. In some cases, a malicious policy owner may use a binary search approach to identify the range of the opposite party. For example, the malicious policy owner may start off with a certain range, e.g., 1-100, 1 having a highest priority for the malicious policy owner. If a positive outcome, e.g., of 40, is provided, the malicious policy owner may understand that 40 is an acceptable value. The malicious policy owner may attempt to select half of the updated range of 1-40, e.g., 1-20 to provide in a next round. If that range is not accepted, a next offer may include the opposing half of the range (optionally excluding the accepted value), e.g. 21-39, and so on, until a lower bound of the opposite party is detected. However, a consistency rate of the malicious policy owner may be determined to be low, resulting in a remedial action such as sending an alert to the opposite party, sending a notification, blocking the malicious policy owner, or the like.

Another technical problem dealt with by the disclosed subject matter is to automate document review processes. For example, a lawyer or any other person may wish to reduce a time of examining documents such as contracts, legal agreements, terms of user, or the like. In some cases, such documents may include a plurality of legal conditions, phrases, or the like, and only a certain percentage of the conditions may be of any interest or relevancy to the user. In some exemplary embodiments, a user such as a lawyer may wish to maintain a certain policy of dealing with certain conditions of the document. However, it may be difficult to implement such a policy without exhaustively reviewing the entire paperwork.

Another technical problem dealt with by the disclosed subject matter is assisting a user to quickly and accurately revise or markup paperwork. In some exemplary embodiments, a user may implement a certain policy of dealing with at least one type of document. Accordingly, the user may wish to perceive highlights of terms in paperwork that corresponds to the type of document that are in contradiction with the policy. For example, a lawyer may desire to view highlights on terms of contracts that do not suit his client's policy. In some cases, the lawyer may desire to receive, for such terms, possible modification suggestions that match his client's policy.

One technical solution of the disclosed subject matter is automating document review processes by creating a policy indicating the preferences of the policy owner regarding the terms, and automatically applying the policy on paperwork or any document. In some exemplary embodiments, an automation method may comprise application of a policy on a document. In some exemplary embodiments, the policy may be converted to an executable form to be applied. Additionally or alternatively, a different executable may be executed to receive the policy as input and process the rules thereof on the document. In some cases, the policy may be a policy that can be used also in the contract formation method. In some exemplary embodiments, the automation method may include obtaining a policy or an executable form thereof at a user device, a server, a cloud node, or the like.

According to a first scenario, the policy may include a first-party-policy including one or more rules that indicate preferences of a first party with respect to one or more terms. The first-party-policy may be created by a first party, a representative of the first party, a server that accumulated information about the first party, or any other user or device. The first-party-policy may be automatically applied on one or more documents to review highlights of terms in the document that are not acceptable by rules of the first-party-policy, review suggested terms that are in line with the first-party-policy, or the like. According to the first scenario, the first-party-policy may be fully accessible to the first party or the first party's representative.

As an example, a lawyer may create a client-policy for his client. According to this example, the client-policy may include one or more rules that indicate preferences of the client with respect to one or more terms in one or more documents. In some cases, the client-policy may be applied on documents to markup terms in the documents as allowed, not allowed, missing, not mentioned in the client-policy, or the like. In some exemplary embodiments, the application of the policy may be performed by converting the policy into an executable program, by executing another program that implements the rules of the policy, or the like.

According to a second scenario, a second-party-policy of a second party may be obtained. The first party may obtain the second-party-policy or an executable form thereof from the second party, with whom he may be negotiating terms of a document. According to this example, the second-party-policy may include one or more rules that indicate preferences of the second party with respect to terms of the document. The first party may apply the rules of the second-party-policy on the document to obtain a display of highlights, each of which may indicate terms that are not acceptable by rules of the second-party-policy. Additionally or alternatively, the user may utilize the display to review preferences of the second party, review suggested terms that are in line with the second-party-policy, or the like. The first party may determine for each new edit to the document performed by the first party whether or not the edit is in line with the second-party-policy, e.g., by applying the second-party-policy on the edit.

In some exemplary embodiments, the second-party-policy may be at least partially not accessible to the first party, for example, in order to keep the rules of the second-party-policy private. Thus, the one or more rules of the second-party-policy may not be directly available to the first party. In some cases, the first party may be provided with an executable program that applies the policy. Additionally or alternatively, the first party may have access to a service for invoking application of the second policy on a document, without having direct access to the policy itself. As an example, a cloud-based service may retain the policy, execute it on a document, and provide output, such as via a web-based application, a Graphical User Interface (GUI), an Application Programming Interface (API), or the like. In some exemplary embodiments, the outcome of applying the second policy on the document may be marking of terms that are unacceptable by the second-party-policy without revealing the one or more rules of the second-party-policy. In some cases, the outcome may suggest one or more alternative terms to replace terms in the document that are unacceptable by the second-party-policy without revealing the one or more rules of the second-party-policy. The first party may accept or decline each suggestion without being given any access to the one or more rules of the second-party-policy. In some exemplary embodiments, the application of the policy by the first party may be limited, such as limited to no more than a predetermined maximal number of times, a predetermined frequency, or the like, e.g., to prevent the first party from reverse engineering the policy such as by deciphering the rules by applying the policy on different variations of the document. In some cases, if the first party applies the second-party-policy on the document or on a portion thereof for a certain number of times, e.g., more than once, an interaction log of the first party may become available to the second party, for example, as a countermeasure. This may discourage the first party from reverse engineering the second-party-policy.

In some exemplary embodiments, the automation method may include classifying each condition in the document as allowed or not allowed by the policy. In some cases, each condition in the document may be marked up and alternative suggestions may be provided for areas in the document that are not allowed by the policy. In some exemplary embodiments, a modification suggestion for a condition may be accepted or declined. In some cases, in response to a decline of one or more modification suggestions, one or more alternative modification suggestions may or may not be provided. In some cases, modification suggestions with a high priority that match the policy may be provided prior to suggestions with a low priority. In other cases, modification suggestions may be randomly provided. In some exemplary embodiments, one or more modification suggestions may be provided from other sources besides the policy such as from the contract database. For example, additional modification suggestion may be generated by detecting in the contract database one or more possible alternative elements that have a high matching score or similarity score to the relevant rule of the policy.

In some cases, the first party may have access to a document under negotiation with the second party, without receiving the second-party-policy of the second party. In some cases, one or more cryptographic schemes may be used to secure the privacy of the second party's policy rules. In other cases, the second-party-policy may be located at a secure or remote location such as a remote server, a cloud node, a trusted user device, a user device of the second party, or the like. The first party may connect to the remote location through a network or through any other communication medium, and transmit to the remote location an entire document or parts thereof that need to be verified via one or more queries. A computing device at the remote location may convert the second-party-policy to an executable program and process the executable program on the received document, queries, or the like. In some cases, results of the processing may include a classification of each condition in the document as allowed or not allowed by the second-party-policy, a markup, alternative suggestions, or the like. However, only partial results may be returned to the first party. In some cases, the first party may receive only yes and no responses as to whether or not a condition is acceptable or not by the second-party-policy. In other cases, the second-party-policy may provide a batch of one or more suggestions from which the first party may select to accept a suggestion or to decline the one or more suggestions.

In some exemplary embodiments, the automation method may include updating the document. In some cases, the document may be updated to include one or more markups of conditions that are allowed by the policy, conditions that are not allowed by the policy, conditions that are required by the policy but are missing, conditions that are preferable by the policy, one or more suggestions of alternative elements for modifying the document, or the like.

One technical effect of utilizing the disclosed subject matter is automating document review processes, e.g., thus reducing human involvement in such processes. In some cases, a policy owner may utilize his own policy to improve an effectiveness and time consumption of document reviews. In other cases, a policy owner may utilize a corresponding policy to reduce human involvement in negotiations and minimize time spent on document reviews. The disclosed subject matter enables to automatically mark up, provide modification suggestions, or the like, to one or more documents according to a personalized policy. This way, a user may eliminate a need to read unnecessary text, thus saving time and enhancing an effectiveness of document review processes.

Another technical effect of utilizing the disclosed subject matter is providing a secure and confidential document review process that takes into account a policy of a different policy owners while keeping the privacy of the different policy owners. Specifically, a user may not have access to rules of a policy of the opposite policy owner.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

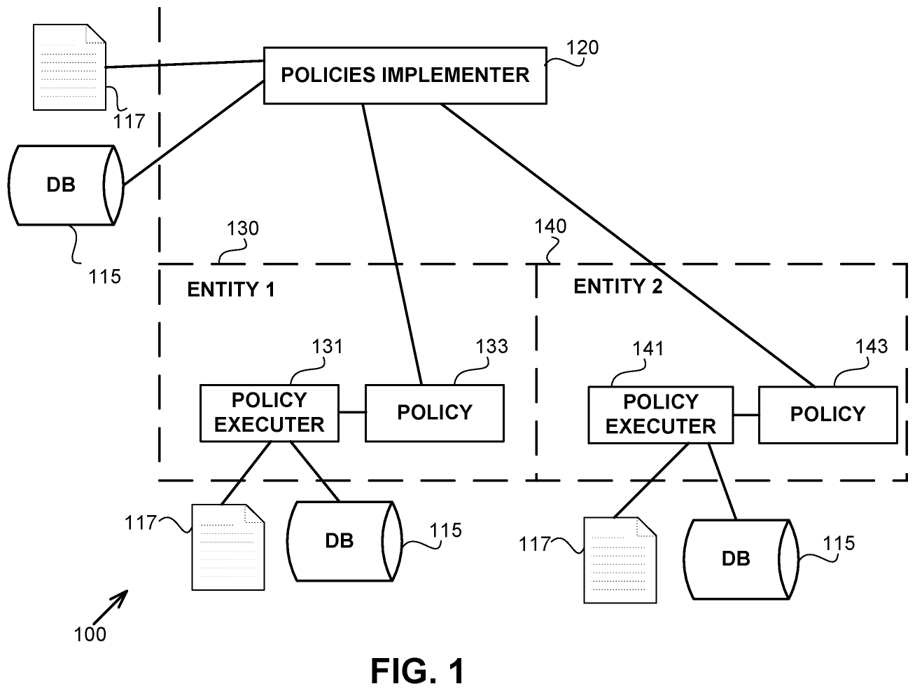

Referring now to FIG. 1 showing an environment, in accordance with some exemplary embodiments of the disclosed subject matter. In some exemplary embodiments, Environment 100 may comprise a First Entity 130 and a Second Entity 140. In some exemplary embodiments, it may be required to determine agreed-upon terms by both Entities 130, 140 for a Document 117. First Entity 130 and Second Entity 140 may represent a first and second policy owner, respectively.

In some exemplary embodiments, First Entity 130 may possess or have direct access to Policy 133, which may include one or more rules representing the preferences of the first policy owner regarding terms or conditions of documents, such as Document 117. Second Entity 140 may possess or have direct access to Policy 143, which may include one or more rules representing the preferences of the second policy owner regarding the conditions of documents, such as Document 117. Policy 133 and Policy 143 may comprise a text file, a script, a computer program, or any other file type or format. In some exemplary embodiments, policies may be defined using a formal language providing a precise representation of the rules defined thereby.

In some exemplary embodiments, First Entity 130 and Second Entity 140 may possess or have access to a software executer, such as Policy Executer 131 and Policy Executer 141, configured to execute rules of a policy, such as Policies 133, 143. In some exemplary embodiments, the rules may be applied to a document, such as Document 117. In some exemplary embodiments, a policy executer, such as 131 or 141, may comprise an interpreter configured to interpret the rules of a policy and apply them on a document. Additionally, or alternatively, a policy executer, such as 131 or 141, may comprise a compiler configured to compile an executable program that is configured to apply the policy on a document. For the ease of explanation, and without limiting the scope of the disclosed subject matter, an application of the policy may be attributed hereinbelow to the policy executer, regardless of the manner in which the policy is applied.

In some exemplary embodiments, when a policy executer, such as Policy Executer 131, applies a policy, such as Policy 133, to a target document, such as Document 117, it may be determined for each condition in the target document, whether or not it is acceptable by the applied policy, whether or not an element is missing, or the like. In some cases, the outcome of the application of the policy executer may generate modification suggestions for conditions that are not allowed by the applied policy.

In some exemplary embodiments, Environment 100 may comprise Policies Implementer 120. In some exemplary embodiments, instead of negotiating conditions of Document 117 between First Entity 130 and Second Entity 140, First Entity 130 and Second Entity 140 may send or provide access to their policies to Policies Implementer 120. Policies Implementer 120 may provide a swift adjustment of terms of Document 117 to comply with the policies of both First Entity 130 and Second Entity 140. In some exemplary embodiments, Policies Implementer 120 may modify Document 117 in a single attempt and without performing repetitive iterations, as opposed to negotiations performed by humans or by computerized agents mimicking the human process.

In some exemplary embodiments, Policies Implementer 120 may be located on a remote server, a cloud node, First Entity 130, Second Entity 140, or the like. Policies Implementer 120 may be configured to obtain Policy 133 and Policy 143 from their policy owners without disclosing content thereof, e.g., rules defined therein, to the opposite policy owner.

In some exemplary embodiments, Document 117 may comprise one or more legal documents such contracts, legal agreements, end-user license terms, privacy policy, terms and conditions of use, or the like. In some exemplary embodiments, content of Document 117 may be negotiated by First Entity 130 and Second Entity 140. In some exemplary embodiments, Policies Implementer 120 may be utilized to modify Document 117 based on potentially contradicting policies, Policies 133, 143.

In some exemplary embodiments, Policies Implementer 120 may be configured to obtain Policy 133, Policy 143, and Document 117. For example, Policy 133 and Policy 143 may be received at Policies Implementer 120 from First Entity 130 and Second Entity 140. In some cases, instead of or in addition to obtaining Policy 133 or Policy 143, an executable form thereof may be obtained. For example, Policy Executer 131 may create an executable form of Policy 133 and provide the executable form to Policies Implementer 120. In some exemplary embodiments, Policies Implementer 120 may include a compiler or an interpreter configured to convert Policy 133 and Policy 143 to executable forms or to interpret the rules of Policy 133 and Policy 143 and apply them on Document 117, e.g., when no executable form is provided. Based on applying of Policy 133 and Policy 143 on Document 117, Policies Implementer 120 may determine for each condition in Document 117 whether or not it is allowed by Policy 133 and Policy 143, whether or not an element that is required or preferred by Policy 133 and Policy 143 is missing in Document 117, or the like. In some cases, Policies Implementer 120 may provide an output that identifies conditions in Document 117 that are not allowed by the first or second policies. In some cases, Policies Implementer 120 may provide an output that includes one or more modification suggestions for conditions of Document 117 that are not allowed, e.g., generated from Policy 133 and Policy 143. In some cases, Policies Implementer 120 may modify conditions of Document 117 to comply with both Policy 133 and Policy 143, select and implement modification suggestions that comply with both Policy 133 and Policy 143, add to Document 117 conditions that comply with both Policy 133 and Policy 143 and are determined to be missing in Document 117, or the like.

In some exemplary embodiments, Environment 100 may include at least one Database (DB) 115. DB 115 may include one or more repositories or computer databases including a plurality of normalized or standard contracts, agreements, phrases, or the like. In some cases, DB 115 may be accessible by First Entity 130, Second Entity 140, Policies Implementer 120, or the like. In some cases, DB 115 may include a plurality of different databases, each of which may be accessible to at least one of First Entity 130, Second Entity 140, and Policies Implementer 120.

In some cases, DB 115 may be utilized by First Entity 130, Second Entity 140, Policies Implementer 120, or the like, for producing or generating Document 117. For example, a type of document such as a “trade contract” may be requested from DB 115, and a corresponding type of document may be obtained from DB 115 in response to the request.

In some cases, DB 115 may be utilized by First Entity 130, Second Entity 140, Policies Implementer 120, or the like, for obtaining normalized representations of conditions of Document 117. DB 115 may provide a boilerplate wording commonly used in documents to manifest the respective condition. Policies Implementer 120, Policy Executer 131, or Policy Executer 141 may receive normalized representations of conditions of Document 117 and apply one or more rules on the normalized representation. Additionally or alternatively, the documents to be processed, such as Document 117, may already make use of the normalized representation and use the boilerplate language.

In some cases, DB 115 may be utilized by Policies Implementer 120 for generating additional modification suggestions, for example, if no suggestions are provided by Policy 133 and Policy 143 for an unacceptable condition, or if suggestions generated by Policy 133 or Policy 143 are not accepted by the both policies. For example, Policy 133 or Policy 143 may provide one or more modification suggestions for a condition in Document 117. However, in case the one or more modification suggestions are not accepted by the opposite policy, one or more additional modification suggestions may be provided from DB 115. For example, Policies Implementer 120 may be configured to extract from DB 115 one or more phrases or elements that are determined to correspond to the condition, e.g., based on a similarity score, a type of document, or any other calculation. In some cases, extracted elements from DB 115 may be utilized as additional modification suggestions.

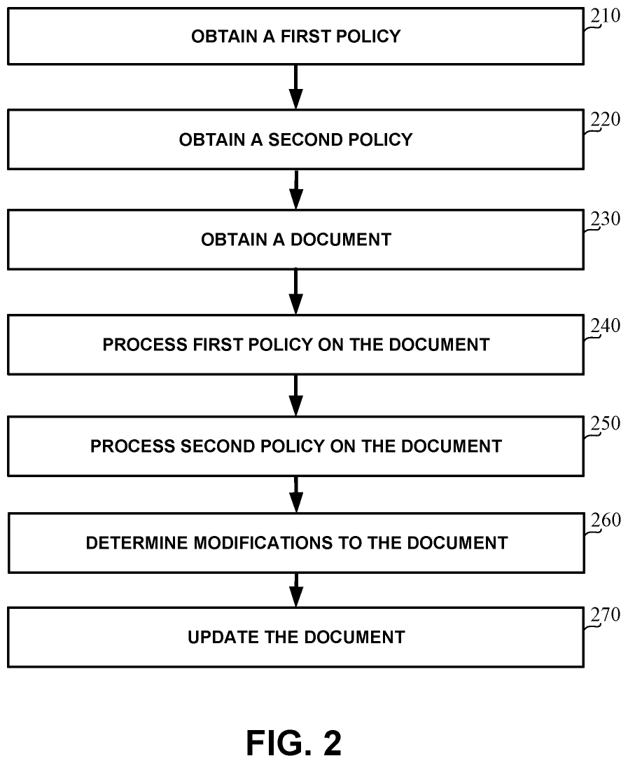

Referring now to FIG. 2 showing a flowchart diagram of the contract formation method, in accordance with some exemplary embodiments of the disclosed subject matter.

On Step 210, a first policy may be obtained from a first edge device. The first policy may include a first set of one or more rules regarding a first set of one or more conditions, respectively. In some cases, an executable form of the one or more rules of the first policy, when applied on a document, may indicate one or more allowed conditions of the document, one or more forbidden conditions of the document, one or more necessary conditions of the document, one or more allowed ranges of conditions of the document, one or more forbidden ranges of conditions of the document, one or more priorities of the conditions, or the like.

In some exemplary embodiments, a policy of a participant may be produced or formed based on a pre-negotiation of rules with the participant, based on rules of the participant directly provided by the participant, based on accumulated information indicting rules of the participant, or the like. In some cases, the participant may determine the rules forming his policy based on his personal interests, his financial interests, his financial status, his political status, or any other personal or non-personal consideration. In some exemplary embodiments, rules of a policy may include, for example, constraints, preferred phrases, preferred terms, unacceptable phrases or terms, acceptable ranges for a condition, unacceptable ranges for a condition, information about roles of participants, or the like.

In some exemplary embodiments, rules of a participant may be gathered and possibly processed to create a policy. In some exemplary embodiments, the policy may be convertible to an executable form. For example, the rules of the participant may be converted to an executable program, which may include machine-executable rules that may be executable in at least one environment. In some cases, the rules of the participant may be provided in a normalized form which may enable a simple compilation or conversion of the rules. For example, an interface of a policy creating procedure may enable a user to select only normalized rules for his policy. In other cases, a user may indicate any rules include normalized and unnormalized rules, which may be later processed to include common phrasing that can be convertible.

In some exemplary embodiments, a policy of an entity may be automatically extracted from a corpus of acceptable documents and rejected versions thereof. The corpus may be utilized to identify acceptable and unacceptable variations of terms, ranges of values for parameters, and the like. Based on the corpus, rules may be automatically extracted to form a policy. In some exemplary embodiments, the policy may be presented to a user for acceptance, modification, or rejection, before the policy may be used.

In some exemplary embodiments, a policy of a participant, including the rules of the participant, may relate to one or more types of documents. In some cases, different types of documents may relate to different rules. For example, rules for construction contracts may differ from rules for trade contracts. In some cases, a policy owner may have one or more policies for one or more corresponding types of documents. For example, a first policy of a policy owner may include rules relating to construction contracts while a second policy of the same policy owner may include rules relating to trade contracts. In other cases, a single policy of a policy owner may include rules that relate to a plurality of types of documents. For example, a policy owner may possess a single policy including rules that relate to both construction contracts and trade contracts.

On Step 220, a second policy or an executable form thereof may be obtained from a second edge device, similarly to Step 210. The second policy may include a second set of one or more rules regarding a second set of one or more conditions, respectively.

In some exemplary embodiments, rules of the first and second policies may be configured to include common phrasing. Specifically, if a rule of the first policy is identical to a rule of the second policy but is described with alternative phrasing, it may be difficult to detect an intersection between the policies even if the alternative phrasing is semantically similar. For example, a condition of a document may include 10 different alternative phrases. The first and second policies may be required to regard the condition in an identical way so that an intersection between the policies may be determined in a simple manner. In some cases, the most common phrasing for the condition may be selected and implemented to eliminate confusion.

On Step 230, a document including one or more conditions may be obtained. In some exemplary embodiments, the one or more conditions of the document may include one or more elements of the document, one or more parameters in an element of the document, one or more ranges of the parameters, one or more phrases of the document, one or more terms of the document, or the like. In some cases, the document may be obtained from the first edge device, the second edge device, a third edge device, a server, a cloud node, or the like. In some exemplary embodiments, the document may include a legal instrument such as a contract the content of which is to be agreed upon both a first policy owner that owns the first policy, and a second policy owner that owns the second policy. In some exemplary embodiments, Steps 210-230 may be performed in parallel, interchangeably, subsequently in any order, or a combination thereof.

In some cases, the document may be produced by the first or second policy owners. In some cases, the first or second policy owners may produce a document that includes one or more initial conditions that are agreed upon. Initial conditions may be marked as such and may be non-modifiable, e.g., excluded from Steps 240-270. For example, when renting an apartment, the first or second policy owner may agree on a rental rate, and produce a rental contract that includes the agreed upon rental rate as a non-modifiable condition. In some cases, the document may be produced by any other user, policy owner, or representative of a policy owner. In some exemplary embodiments, the document may be created at least semi automatically, for example, based on one or more policy rules. For example, the document may be created to include terms associated with the first policy. In some exemplary embodiments, the document may be produced based on at least one contract database including a plurality of contracts with normalized or standard phrasing. For example, the document may include a standard trade contract which may be retained in the contract database. In some cases, the document may be produced partially by a policy owner and partially from an external source. For example, if one or more initial conditions are agreed upon in a rental contract, a policy owner may generate a rental contract including the initial conditions, and add any other conditions from other sources, e.g., a contract database, based on policy rules, or the like.

In some exemplary embodiments, a contract database may include a repository or computer database including a plurality of normalized or standard contracts, agreements, phrases, or the like. In some cases, the contract database may form a starting point for constructing a contract. In this case, a type of document such as a trade contract may be requested, and a corresponding document may be obtained from the contract database in response to the request. Initial conditions may or may not be added to the obtained document. In some exemplary embodiments, common textual patterns may be extracted from specific types of documents in the contract database such as types of contracts, types of agreements, or the like. In some cases, correlation and anti-correlation information regarding a common presence or absence of certain terms in the specific types of documents may be determined. The textual patterns and correlations may be prioritized according to how common they are in the contract database, while high priority textual patterns may be selected prior to low priority textual patterns, e.g., for modification suggestions, document generations, modifications, or representation in a normalized form, or the like.

On Step 240, the first set of one or more rules may be applied on the document, for example, to classify each condition in the document as allowed or not allowed by the first policy. In some cases, conditions in the document may be marked up and alternative suggestions may be provided for areas in the document that are not allowed by the first policy.

On Step 250, the second set of one or more rules may be applied on the document, for example, to classify each condition of the one or more conditions in the document as allowed or not allowed by the second policy. In some cases, conditions in the document may be marked up and alternative suggestions may be provided for areas in the document that are not allowed by the first policy. In some exemplary embodiments, Steps 240 and 250 may be performed in parallel, interchangeably, subsequently, or a combination thereof.

In some exemplary embodiments, the one or more conditions of the document may be compared to the contract database to determine a normalized representation of the one or more conditions. The contract database may include normalized representations of conditions, including a boilerplate wording used in documents to manifest the respective condition. Subsequently, the first and second policies may be applied on the normalized representation of the one or more conditions to classify each condition in the document as allowed or not allowed.

In some exemplary embodiments, if a condition is regarded with identical phrasing by both the first and second policies, but is not detected in an associated document, conditions in the document may be processed and compared to standard formats to determine whether the condition is located in the document but has alternative phrasing or whether the condition is indeed missing in the document.

On Step 260, one or more modifications to the document may be determined based on the application of the first and second policies. In some exemplary embodiments, the outcome of processing a policy on a document may be to modify a term from one form to another. In some exemplary embodiments, the determination may not necessarily change the meaning of the term. However, the policy owner may have approved boilerplate language that was vetted and should be used.

In some exemplary embodiments, the first and second sets of one or more rules may be utilized to examine the document and apply thereto the first and second policies. Based on the examination of the document, additional elements to the document may be suggested, modifications to elements of the document may be suggested, missing elements may be provided or suggested, elements that contradict the first or second policy may be marked up, or the like. An explanation for modification suggestions may or may not be added. In some cases, an explanation may be added when an element is not accepted, or at any other occasion. In some cases, the explanation may include a rule of a policy that contradict the associated element of the document.

In some exemplary embodiments, missing elements may be suggested for the document. In some cases, an analysis of the document based on a policy may determine that one or more elements that are required or preferred by the policy are missing. For example, an exclusive jurisdiction clause, limiting may be missing in a contract. In some exemplary embodiments, one or more alternatives may be suggested for the missing elements of the document based on the policy, the contract database, or the like. In some exemplary embodiments, the suggestion may already take into account both policies, such as by suggesting a clause that would be acceptable according to both policies.

In some exemplary embodiments, the one or more alternatives for the missing elements may be generated from the first or second policy. However, if the one or more alternatives are not acceptable by the opposite policy, or if no alternatives for the missing elements are generated at all from the first or second policy, potential alternatives may be determined based on the contract database or based on any other source of information.

In some exemplary embodiments, a modification suggestion may or may not include additional information such as a matching level of the suggestion to each policy, a matching score to each policy, a normalization score, a success probability of an alternative element to comply with the rules of the other policy, a likeliness of the second party to agree to each alternative element, or the like.

In some exemplary embodiments, a condition of the document that is not allowed by the first policy or by the second policy may be modified. In some exemplary embodiments, a modification may include adding to the document portions that identify, e.g., visually, the condition in the document that is not allowed by the first or second policies. In some exemplary embodiments, a modification may include adding one or more suggested amendments to the condition that is not allowed, e.g., in the form of notes, highlighted text, or the like. In some exemplary embodiments, the condition may be modified to comply with the respective policy. For example, if a condition in the document is allowed by the first policy but not by the second policy, the condition may be modified to comply with both policies.

In some cases, automatic suggestions for modifications may be generated from the contract database, generated from the first or second policy, predetermined, or the like. In some cases, automatic suggestions may be produced by a Natural Language Processing (NLP) model or by any other algorithm or classifier, for example, based on a database, policy rules, or the like. In some cases, automatic suggestions may be marked up.

In some exemplary embodiments, a plurality of automatic suggestions for an element that contradicts the first or second policy, may be compared to each other and scored according to a matching level to the first and second policies. In some cases, the matching level may be determined by applying the first and second policies on the automatic suggestions, determining a difference between the automatic suggestions and corresponding rules, determining whether or not an automatic suggestion is similar to a rule of the first and second policies but has different phrasing, or the like. An automatic suggestion that has a highest score regarding the first and second policies, or regarding a policy that has a higher priority, may be selected and implemented in the document.

In some exemplary embodiments, modifications to elements of the document may include alternative suggested elements configured to replace a section in the document that contradicts the first policy, the second policy, or both policies. In some cases, a contradiction to a policy may be determined when a similarity score between a policy rule and a corresponding term is below a threshold. Modifications may include one or more text phrases, a modified range, a modified condition, or the like. As an example, a section in the document may define a range of 1-2 for a number of permissible car parking, and a rule of a policy may require a range of 2-5 permissible car parking. Accordingly, a modified range of 2-5 may be suggested by the policy.

In some exemplary embodiments, if modifications generated from the first or second policy are not acceptable by the opposite policy, or if no modifications are generated from the first or second policy with regards to a certain condition, potential modifications may be determined based on other data sources such as the contract database. In some cases, a phrase or range from the contract database that is most similar to a rule of the first and second policies may be selected and implemented in the document. In some cases, a classifier or any algorithm may utilize the contract database to select potential modifications based on previously successful selections, based on a similarity score, or the like.

In some exemplary embodiments, one or more different alternatives to a same section in the document may be suggested. In some cases, the one or more different alternatives may be scored based how well they suit the first and second policies, how similar they are, or the like, which may be determined by one or more classifiers, functions, algorithms, rules, or the like. In some exemplary embodiments, there may be several scores to each alternative, such as a score indicating suitability to the first policy and a second score indicating suitability to the second policy. The selection of the alternative to be implemented may be performed using a resolution process that takes into account the different scores, relative power between entities, selections of other alternatives, overall scores of other selections made, or the like.

In some exemplary embodiments, a condition that is indicated as preferable or necessary by a rule of the first or second policy and is not indicated as excluded by a rule of the second or first policy, may be determined to be missing in the document. For example, the first policy may require a condition such as a certain phrase, and the second policy may not have a conflicting rule that excludes such a phrase. In such cases, the certain phrase may be determined to be missing in the document. In some exemplary embodiments, a condition that is determined to be missing may be added to the document, whereby the updated document includes the missing condition. In some cases, if a condition is indicated as necessary by the first policy and as excluded by the second policy, the condition may be marked up and returned for non-automated negotiation. For example, a phrase such as “no responsibility is guaranteed” may be required by rules of the first policy, but may be required to be excluded by rules of the second policy. In such cases, the phrase “no responsibility is guaranteed” may not be considered to be missing.

In some exemplary embodiments, if no resolution is found for an element that contradicts the first or second policy, the element may be marked up and returned to the first and second owners of the first and second policies for traditional non-automated negotiation. In this case, a partial resolution is achieved and only the element for which no resolution is found may require an actual negotiation. In some cases, the partial resolution may include providing the updated document to the first and second edge devices. The updated document may include a plurality of elements that suit the first and second policies and a markup of one or more problematic elements for which no resolution was found.

In some exemplary embodiments, an intersection between the first and second policies may include not one parameter but a range of parameters. For example, the first policy may indicate that any value between a range of 5-15 is acceptable for a certain condition, and the second policy may indicate that any value between a range of 1-14 is acceptable for the same condition. According to this example, an intersection between the first and second policies includes a range of values 5-14. In some cases, a parameter for the condition may be selected from the intersection range based on a determined balance between the first and second policies, randomly, or the like.

In some exemplary embodiments, parameters of rules of policies may or may not be prioritized, and, for each intersection range between a first rule of the first policy and between a second rule of the second policy, a parameter in the intersection range may be randomly selected.

In some exemplary embodiments, parameters or values of rules of policies may be prioritized, e.g., based on preferences of a policy owner. In some exemplary embodiments, the first policy may define priorities with respect to the first set of one or more rules and the second policy may define priorities with respect to the second set of one or more rules. In some exemplary embodiments, an intersection between two prioritized rules regarding the same condition may include a range of prioritized parameters. In some cases, an intersection range of a rule of the first policy may be prioritized in an opposite order than an intersection range of a corresponding rule of the second policy. For example, a rule of the first policy regarding a condition may include a range of 2-5 with 5 having the highest priority, while a rule of the second policy regarding the same condition may include a range of 2-6 with 2 having has the highest priority.

In some exemplary embodiments, the priorities of the policies may relate to an intersection range of parameters, to a number of different parameters that are not bound in a certain range (such as parameters valued 4 or 8 excluding values 5-7) or to an intersection of continuous parameters. An example for a rule that relates to a continuous parameter may include selecting any parameter that has a value above a certain threshold. For example, the first policy may require a parameter that has a value above two, and the second policy may require a parameter that has a value above three. Thus, an intersection range between the rules may include a continuous parameter that has a value above three. As another example, the first policy may require for a condition a parameter that has a value above two, and the second policy may require for the condition a parameter that has a value below five. Thus, an intersection range between the rules may include a parameter that is above two and below five.

In some exemplary embodiments, some rules of a policy may relate to parameters that may be prioritized, while other rules may be considered discrete, without a prioritized set of parameter values. In some cases, a rule may be considered discrete if it either allows or does not allow a certain phrase or element. For example, a discrete rule in a policy of Alice may indicate that the phrase “Alice is not responsible for any damage to the car” is mandatory for any car-related agreement. Such a discrete rule does not relate to values of parameters, but rather to a presence or absence of a phrase in a document. It is noted that although a discrete rule may not have prioritized parameters or values, suggestions of modifications for a discrete rule may be prioritized according to how well the suggestions suit the discrete rule based on similarity scores. For example, a phrase “no responsibility is taken for any car damages” may be scored higher by similarity parameters that a phrase “Alice is responsible to all car damages”, in comparison to the required phrase “Alice is not responsible for any damage to the car”. In some cases, a discrete rule may be scored according to a flexibility level that may be permitted. For example, if no flexibility is permitted at all, the phrase “no responsibility is taken for any car damages” may not be allowed by a rule requiring the phrase “Alice is not responsible for any damage to the car”, although they both have the same meaning.

In some exemplary embodiments, rules (e.g., discrete rules, non-discrete rules with alternative parameter values, or the like) of a policy may be prioritized therebetween based on importance. For example, a policy owner may prefer, to some extent, to have a certain discrete rule but may be willing to compromise on the rule if it contradicts the opposite policy or under any other condition. In some exemplary embodiments, there may be a set of rules, and the resolution may include a compromise implementing only a portion thereof on the document. For example, a policy owner named Lucy may prefer that a contract will include the phrase “Lucy shall receive a yellow candy every morning”, but she might be willing to compromise on a statement with similar meaning (e.g., a different colored candy), with different phrasing, or she might be willing to compromise entirely on the condition. In such cases, a calculation of the balance between the priorities of the first and second policies may take into account a priority assigned the rule.

In some exemplary embodiments, a parameter for an intersection between two prioritized rules regarding a condition may be selected based on a balance between the priorities defined by the policies. In some exemplary embodiments, the condition may be modified to include the selected parameter based on the determined balance between the priorities. In some exemplary embodiments, a balance between the priorities defined by the policies may include a local balance, a relative or absolute power balance, an overall equal balance, a random balance, an overall unequal balance, or the like.

In some cases, one or more selections of parameters may be performed with respect to a first set of one or more intersection ranges between the first policy and the second policy that favors the first policy, while one or more selections of parameters may be performed with respect to a second set of one or more intersection ranges between the first policy and the second policy that favors the second policy. In some exemplary embodiments, a ratio between the first set and the second set may be based on the determined balance between the priorities. In some cases, the balance may include an overall equal balance in which the ratio may be approximately 1:1. In some exemplary embodiments, the ratio may be between the selection so that for each selection that favors one policy there is about one selection that favors the other. Additionally or alternatively, the ratio may also take into account the distance of the values of each selection. The distance may be normalized, and a ratio of 1:1 in the overall distance so that the normalized sum of all distances may be about zero.

In some cases, the balance between the priorities of the first and second policies may include a random balance in which the ratio may be determined randomly. Accordingly, a parameter for an intersection range between the first and second rules may be selected based on a determined random balance between the priorities of the first and second policies. In some cases, the random balance may be local. In such cases, a local random balance may be implemented by determining, every time a parameter for an intersection range is to be selected, a new random value between 0 and 1, and selecting the parameter proportionally. In other cases, the random balance may be an overall balance. For example, if an overall balance is randomly determined to be a value between 0 and 1 such as ⅔ in favor of the first policy, the parameter for the intersection range between the first and second rules may be selected based on a calculation that aims for an overall balance of ⅔ in favor of the priorities of the first policy.

In some cases, the balance between the priorities defined by the first and second policies may be determined to be a local balance. In some cases, the first policy may define a first priority for a first rule, while the second policy may define a second priority for a second rule. In some exemplary embodiments, a parameter for an intersection range between the first and second rules may be selected by determining that the first rule has a higher priority than the second rule, and biasing the selection of the parameter to favor the first rule. For example, the first priority may define a priority score of 5, while the second priority may define a priority score of 4. According to this example, the selection of the parameter may be biased to favor the first rule having higher priority. In some exemplary embodiments, the document may be modified to include the selected parameter. For the avoidance of doubt, in case the second priority of the second rule has a higher priority than the first priority of the first rule, the selection may be biased towards the second rule. For the purpose of simplicity and clarity, but without loss of generality, the description of disclosed subject matter focuses on the cases where the first rule is preferred over the second rule. It is noted that in some embodiments, priorities of all the rules of a policy may be normalized, so that the priority may be a relative priority within the policy. As a result, a local balance may generally enable a fair solution that biases the selection of some rules in favor of one entity, and other rules in favor of another, based on their own preferences, as revealed by the priorities. Additionally or alternatively, the biasing may also take into account the difference in priorities between the two rules. As an example, if the first entity defined the range 1-10 with a priority of 0.4, and the second entity defined the range 5-15, with a priority of 0.2, then the selection of a value from the overlapping range of 5-10 may be performed based on the 1:2 ratio in priorities. In some exemplary embodiments, the ratio may be utilized to bias a random decision. Additionally or alternatively, the ratio may be used to calculate deterministically the selected value, such as selecting the 33% percentile in the range (e.g., the value 6.65 or a value within a predetermined range therefrom, a closest or close integer, such as 6 or 7, or the like).

In some cases, the balance between the priorities defined by the first and second policies may be determined to be a power balance. In some exemplary embodiments, the document under negotiation may include a legal document setting conditions between a first entity and a second entity, wherein the first policy may be a policy of the first entity and the second policy may be a policy of the second entity. In some exemplary embodiments, the first policy may define a first priority for a first rule, while the second policy may define a second priority for a second rule. In some exemplary embodiments, a selection of a parameter for an intersection range between the first rule and the second rule may be biasing to favor an entity having a greater estimated power. In some cases, an estimated relative power of the first entity, e.g., relative to the second entity, may be determined to be greater than the estimated relative power of the second entity. In this case, a parameter for the intersection range may be biased to favor the first rule. In other cases, an estimated relative power of the second entity may be determined to be greater than the estimated relative power of the first entity. In some exemplary embodiments, a power balance may be determined based on participant's roles, a direct input, analyzed data, or the like. In some exemplary embodiments, the document may be modified to include the selected parameter for the intersection range. In some exemplary embodiments, the first rule of the first policy may comprise a first range of parameters for a condition of the document, and the second rule of the second policy may comprise a second range of parameters for the condition of the document. In some exemplary embodiments, the first range and the second range may overlap at the intersection range of parameters, and a parameter for the intersection range may be selected by biasing to favor a priority of an entity having a greater estimated power.

In some exemplary embodiments, a bias may be absolute or relative. In some cases, an absolute bias may be implemented by identifying a highest-utility parameter in the intersection range having a highest utility for the entity with the greater estimated power, and selecting the highest-utility parameter for the document. In some cases, a relative bias may be implemented by identifying a relatively high parameter in the intersection range having a relatively higher utility for the entity with the greater estimated power, and selecting the relatively high parameter. In some cases, the relative bias may be proportional to the power gap between the parties.

As an example, a manufacturer that manufactures and sells merchandise may have greater estimated power than a purchaser of merchandise. The manufacturer may provide a warranty ranged from 1-4 years for the merchandise, one year being the highest priority for the manufacturer, and the purchaser may have a preferred warranty range of 2-5 years, 5 years being the highest priority for the purchaser. Accordingly, a warranty range of 2-4 years overlaps both ranges. In some exemplary embodiments, when an absolute bias is implemented, a warranty of 2 years may be selected since 2 is the highest-utility parameter in the overlapping range from the manufacturer's point of view. Such a selection may be performed by a resolution function that is based on the balance of powers and which implements an absolute preference to more powerful entity.

In some exemplary embodiments, the first range may be defined by the first rule of the first policy with respect to a condition of the document and the second range may be defined by the second rule of the second policy with respect to the condition. In some exemplary embodiments, the first range and the second range may be determined to be disjoint, e.g., when the first range and the second range do not overlap. In some exemplary embodiments, upon determining that the first and second ranges are disjoint, a notification that automated resolution cannot be performed with respect to the condition may be provided.

In some cases, the balance between the priorities of the first and second policies may be determined based on a direct input, a predetermined value, or based on any other method. In some exemplary embodiments, big data analysis may be utilized to determine relative power balances between the parties, such as based on media reports, economic indicators, or the like. Additionally or alternatively, publicly available economic indicators of the parties, such as available in view of the companies being publicly traded, may be obtained and utilized. As an example, the balance of powers may be determined based on the relative market values of each party. In some exemplary embodiments, the proportion between the market values of the companies may be utilized. For example, in case the proportion between the companies is above a predetermined threshold, such as above 1:10, 1:20, 1:100, or the like, it may be determined that one party has an increased relative power over the other.

On Step 270, the document may be updated based on the determination of Step 260. In some exemplary embodiments, the updated document may be provided to the owners of the policies. Additionally or alternatively, the updated document may be transmitted to a different device, such as a server, and edge computer, a client device, or the like.

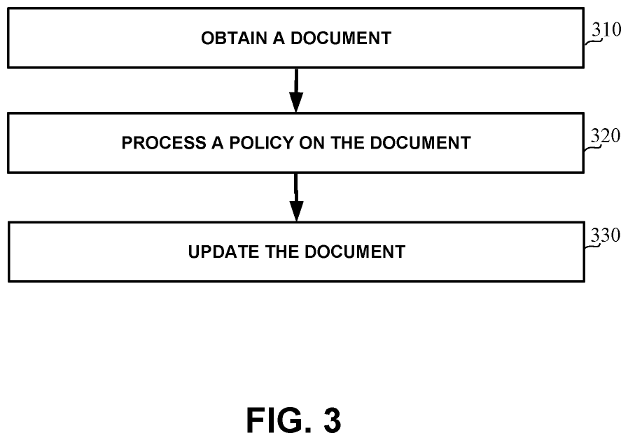

Referring now to FIG. 3 showing a flowchart diagram of an automation method, in accordance with some exemplary embodiments of the disclosed subject matter.

On Step 310, a document including one or more conditions may be obtained. In some cases, the document may be obtained from the contract database or generated based on a boilerplate contract retained therein. In some cases, the document may correspond to the document described with respect to FIG. 2.

In some cases, a policy for the document may include one or more rules regarding one or more conditions. In some cases, the policy may correspond to the policy described with respect to FIG. 2. In some cases, the policy may be located at a user's device. In other cases, the policy may be located at a remote location such as a remote server, a remote device, a cloud, or the like, while remaining at least partially accessible to the user's device. According to this example, the policy may be reachable via one or more communication mediums.

On Step 320, the policy, comprising the one or more rules, may be processed on the document, for example, to classify each condition in the document as allowed or not allowed by the policy. In some cases, the policy may be applied by executing an executable that is generated based thereon, by executing a software tool that implements a policy provided thereto as an input, or the like. In some cases, the usage of an executable may restrict the ability of a third party to understand the content of the policy and the rules that are applied thereby.

In some exemplary embodiments, a first party may utilize its own first policy to examine a document. The first party or its representative may review the document and aim to modify the document so that it will be acceptable by the first policy. Using the first policy, the first party may automatically detect any elements in the document that contradict the first policy, that are required by the first policy but are not included the document, or the like. One or more modifications to the document may be suggested based on the first policy or based on the contract database.

In some exemplary embodiments, a first party may utilize a policy of a second party to examine a document. The first party may review the document and aim to modify the document so that it will be acceptable by both parties. Using the policy of the second party, the first party may detect any elements in the document that contradict the policy of the second party, that are required by the policy of the second party but are not included the document, or the like. One or more modifications to the document may be suggested to overcome future objections of the second party.

In some cases, the first party may edit any element in the document that is not allowed by the first party, and for each edit, determine whether or not the edit may be acceptable by the second party, for example, by applying the second party's policy on the edited version, on the a path representing the difference between the two documents (e.g., representing the edit itself), or the like. Additionally or alternatively, the first party may view any missing element that is required by the second party's policy but is not included in the document. In some cases, by editing all elements that are not acceptable by the second party's policy to new elements that are acceptable to both sides, the first party may have a high validation rate of the document and a high probability of receiving a ratification from the second party. In case that the second party's policy with regards to a certain element is not acceptable by the first party, negotiation may be held with regards to the limited area that is in dispute.

In some exemplary embodiments, the second party may be concerned that the first party will take advantage of having full access to the policy of the second party. Specifically, having full access to the policy of the second party has a risk of allowing the first party to select suggestions that are acceptable to both parties but are more advantageous to the first party. Typically, interests of a first party may oppositely correspond to interests of a second party.

As an example, there may be five alternative phrases for an element of the contract that are acceptable according to the policy of the second party. If the first party has full access to the policy of the second party, he may detect the five alternative phrases and select from the five alternative phrases a phrase that is preferable to the first party, although the selected phrase may be not preferable for the second policy.

As another example, there may be a range of parameters for an element of the contract that are acceptable according to the policy of the second party. For example, the first party may prefer to receive a liability of 1,000,000 dollars from the second party. Such an amount may not be accepted by the policy of the second party. If the first party has full access to the policy of the second party, he may detect that the second party has acceptable liability sums that range between 250,000 and 900,000 dollars. Accordingly, the first party may select a sum of 900,000 which is preferable for the first party but has a lowest priority for the second party.

In some exemplary embodiments, to solve this concern, the policy of the second party may not be fully exposed to the first party. Instead, the first party may interact with the policy of the second party as a “black box” that can only accept or reject offers. This way, the first party may not be able to view rules that are acceptable by the second party and exploit that information. In other cases, the policy of the second party may enable limited access to one or more suggestions. For example, the policy of the second party may display a first batch of one or more suggestions to the first party, and if none of them satisfy the first party, a second batch of possible suggestions may be displayed.

In some exemplary embodiments, a “black box” interaction may be implemented by locating the policy of the second party on a remote server such as a cloud server, by implementing a secure MPC scheme, or the like. In some cases, the remote server may apply the policy of the second party on inputs and return to the first party outputs that do not expose the rules of the policy of the second party. In some exemplary embodiments, the “black box” interaction between the first party and the policy of the second party may be recorded so that any problematic behavior, such as trying all different possible values, may be detected. In some cases, a number of queries to the “black box” may be recorded. This may reduce a likelihood of malicious activities. In some exemplary embodiments, machine learning may be employed to classify problematic usage patterns. The machine learning may be implemented using a classifier, a clustering module, an Artificial Neural Network (ANN), or the like. In some exemplary embodiments, the machine learning may be provided with features representing the sequence of applications of the policy, such as a sequence of ten previous applications of the policy. Each application may be characterized by the difference from a previous application (or previous applications), potentially enabling identification of artificial modifications that are aimed at gaming the system and reverse engineering the policy to learn the content of the rules that are being applied. In some exemplary embodiments, a number of applications of the policy within a timeframe may also be useful to identify potential malicious behavior. Additionally or alternatively, data points representing variations of the same document for the same entity over time may be employed. Problematic behavior may be exhibited by a sequence of modifications of the same document in contradicting manners, in a sequence of minor modifications of the same element, or the like.

On Step 330, the document may be updated to provide an updated document. In some exemplary embodiments, the updated document may include one or more markups, one or more suggestions of modifications, or the like. In some cases, a condition of the document that is not allowed by the policy may be suggested to be modified to comply with the rules of the policy. In some cases, automatic suggestions for modifications may be generated from the contract database, generated from the policy, inputted from a user, predetermined, or the like. In some exemplary embodiments, automatic modifications may be implemented based on a score of the one or more suggestions, and marked up accordingly. A user may be able to reverse such modifications, select a different suggestion, view scores of different suggestions, or the like.

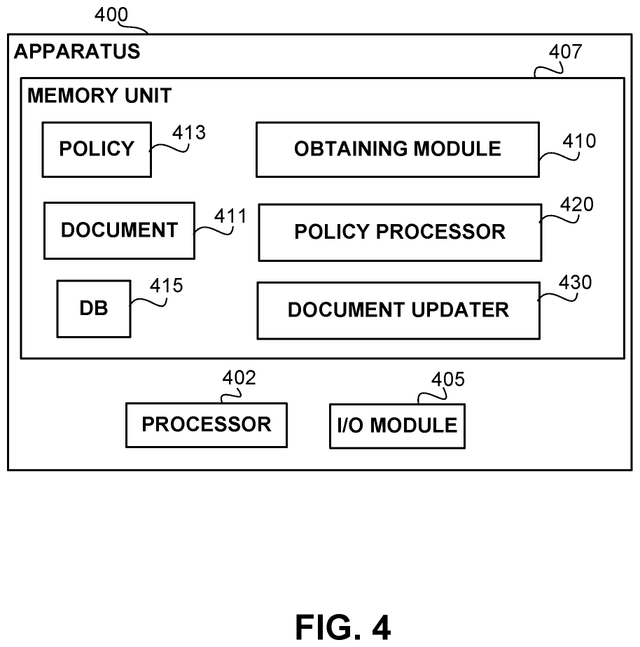

Referring now to FIG. 4 showing a block diagram of components of an apparatus, in accordance with some exemplary embodiments of the disclosed subject matter.

In some exemplary embodiments, Apparatus 400 may comprise a Processor 402. Processor 402 may be a Central Processing Unit (CPU), a microprocessor, an electronic circuit, an Integrated Circuit (IC) or the like. Processor 402 may be utilized to perform computations required by Apparatus 400 or any of its subcomponents. Processor 402 may be configured to execute computer-programs useful in performing the methods of FIG. 2, FIG. 3, or the like. In some exemplary embodiments, Apparatus 400 may be an independent server, not controlled by any one of the policy owners, so as to prevent data leakage therefrom. Additionally or alternatively, Apparatus 400 may be owned, operated, or otherwise controlled by one of the policy owners. In some embodiments, Apparatus 400 may be utilized the purpose of applying a single policy on a document, such as the policy of the policy owner. Additionally or alternatively, Apparatus 400 may be utilized to apply a plurality of policies or policies of third parties, either in a protective manner (e.g., using MPC, using 2PC, using executable form that underwent obfuscation or encryption, or the like), or in a non-protective manner.

In some exemplary embodiments of the disclosed subject matter, an Input/Output (I/O) Module 405 may be utilized to provide an output to and receive input from a user. I/O Module 405 may further be used to transmit and receive information to and from the user or any other apparatus in communication therewith.

In some exemplary embodiments, Apparatus 400 may comprise a Memory Unit 407. Memory Unit 407 may be a short-term storage device or long-term storage device. Memory Unit 407 may be a persistent storage or volatile storage. Memory Unit 407 may be a disk drive, a Flash disk, a Random Access Memory (RAM), a memory chip, or the like. In some exemplary embodiments, Memory Unit 407 may retain program code operative to cause Processor 402 to perform acts associated with any of the subcomponents of Apparatus 400. In some exemplary embodiments, Memory Unit 407 may retain program code operative to cause Processor 402 to perform acts associated with any of the steps in FIG. 2, FIG. 3, or the like.

The components detailed below may be implemented as one or more sets of interrelated computer instructions, executed for example by Processor 402 or by another processor. The components may be arranged as one or more executable files, dynamic libraries, static libraries, methods, functions, services, or the like, programmed in any programming language and under any computing environment.

In some exemplary embodiments, Obtaining Module 410 may be configured to obtain Policy 413 and Document 411, for example, via I/O Module 405 or via any other component or device. In some cases, Policy 413 may include one or more policies of one or more policy owners. For example, Policy 413 may include a first policy of a first policy owner obtained from a first edge device and a second policy of a second policy owner obtained from a second edge device. In some cases, Policy 413 may include a policy of a user that is used for quick examination of paperwork, and Document 411 may include paperwork that is to be dealt with by the user. In some cases, Document 411 may include a contract, a legal agreement, terms of use, or the like.

In some exemplary embodiments, Obtaining Module 410 may be located at a remote server, a remote device, a cloud node, a trusted computing device, a user's device, a combination thereof, or the like.

In some exemplary embodiments, rules of Policy 413 may include, for example, constraints, preferred phrases, preferred terms, unacceptable phrases or term, acceptable ranges for a condition, unacceptable ranges for a condition, information about roles of participants, or the like. The rules of Policy 413 may relate to one or more conditions.

In some exemplary embodiments, Policy Processor 420 may be configured to apply Policy 413 on Document 411 to classify each condition in Document 411 as allowed or not allowed by Policy 413. Policy Processor 420 may be located at a same location as Obtaining Module 410.

Policy Processor 420 may provide one or more modification suggestions to Document 411 such as a suggested text amendment, a suggested range amendment, markups of areas of the document that contradict Policy 413, markups of possible amendments to the document, or the like. In some cases, modification suggestions may be generated from Policy 413, Contract Database 415, or any other source. In some cases, the modification suggestions may be scored according to how well they match Policy 413, a level of normalization of the phrasing, and based on a determined balance between determined priorities of each rule of Policy 413.

In some exemplary embodiments, different suggestions may be provided to the different policy owners. For example, consider a scenario where there are three clauses in a document. The first clause is acceptable as is for both polices. The second clause is not acceptable to both policies (e.g., either rejected by one or by both), but can be automatically amended to be in line with both policies. The third clause is acceptable for the first policy but unacceptable for the second policy, with no automated suggestion to resolve the conflict. In such a case, the owner of the first policy may be notified of the suggested amendment to the second clause, and may receive an indication that all other clauses are acceptable according to the first policy but there is an unresolvable conflict regarding other clauses. The owner of the second policy, on the other hand, may receive a notification regarding the suggested amendment of the second clause and an indication that the third clause is unacceptable according to his policy and cannot be modified to be accepted by both policies. Such an embodiment may reduce the amount of information disclosed to the owner of the first policy regarding the second policy. Additionally or alternatively, other non-symmetrical outputs may be provided to policy owners or users. Additionally or alternatively, as the first policy accepts the modified document, the notification to the owner of the first policy may be of a reduced urgency in comparison to the notification to the owner of the second policy. In some cases, the notification to the owner of the second policy may indicate that he is tasked with resolving the issue, in a manual manner. Additionally or alternatively, the notification to the owner of the first policy may indicate that the other party is the one in charge of handling the resolution.

In some exemplary embodiments, Document Updater 430 may be configured to update Document 411 to provide an updated Document 411. In some exemplary embodiments, updated Document 411 may include portions that identify, e.g., visually, conditions that are not allowed by Policy 413. In some exemplary embodiments, updated Document 411 may include one or more suggested amendments to the conditions that are not allowed, e.g., in the form of notes, highlighted text, or the like. In some cases, a condition of Document 411 that is not allowed by Policy 413 may be modified to comply with Policy 413. For example, if a condition in Document 411 is allowed by the first policy of Policy 413 but not by the second policy of Policy 413, the condition may be modified to comply with both policies. Document Updater 430 may modify the condition based on modification suggestions generated by Policy Processor 420, Contract Database 415, or any other source. In some cases, a modification suggestion with a highest score may be selected and Document 411 may be updated accordingly.

In some exemplary embodiments, Document Updater 430 may update Document 411 based on Policy 413, for example, without disclosing a content of any policy of Policy 413 to another user or participant.

In some exemplary embodiments, if no acceptable terms are found for an element in Document 411, the element may be returned for negotiation between the first and second parties.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining a first policy from a first edge device, wherein the first policy comprises a first set of one or more rules regarding a first set of one or more conditions, respectively;
obtaining a second policy from a second edge device, wherein the second policy comprises a second set of one or more rules regarding a second set of one or more conditions, respectively;
obtaining a document comprising one or more conditions;
processing the first set of one or more rules on the document to classify each condition of the one or more conditions in the document as allowed or not allowed by the first policy;
processing the second set of one or more rules on the document to classify each condition of the one or more conditions in the document as allowed or not allowed by the second policy; and
providing an output that identifies conditions of the one or more conditions in the document that are not allowed by at least one of the first and second policies,
wherein the output is provided without disclosing a content of the first policy to the second edge device and without disclosing a content of the second policy to the first edge device.

2. The method of claim 1, wherein said providing the output comprises providing an update for the document, wherein the update comprises a modification of at least one condition of the document that is not allowed by the first policy or by the second policy to comply with the first or second sets of one or more rules.

3. The method of claim 2 further comprises updating the document to provide the updated document, and providing the updated document to the first and second edge devices.

4. The method of claim 2 further comprises:
determining that a condition indicated as a preferable by a rule of the first or second sets of one or more rules and not indicated as excluded by a rule of the second or first sets of one or more rules, respectively, is missing in the document; and
wherein said updating comprises adding the condition to the document, whereby the updated document comprises the condition.

5. The method of claim 1 further comprises comparing the one or more conditions of the document to a database to determine a normalized representation of the one or more conditions, wherein the database comprises a normalized representations of conditions, each of which comprises a boilerplate wording used in documents to manifest the respective condition, and processing the first and second sets of one or more rules on the normalized representation of the one or more conditions.

6. The method of claim 1,
wherein the first policy defines priorities with respect to at least a portion of the first set of one or more rules;
wherein the second policy defines priorities with respect to at least a portion of the second set of one or more rules; and
wherein said modifying is performed based on a balance between the priorities defined by the first and second policies.

7. The method of claim 6,
wherein the balance is a local balance;
wherein the first policy defines a first priority for a first rule;
wherein the second policy defines a second priority for a second rule;
wherein said modifying comprises selecting a parameter for an intersection range between the first rule and the second rule, wherein said selecting comprises:
determining that the first priority is a higher priority than the second priority; and
biasing the selection of the parameter to favor the first rule.

8. The method of claim 6,
wherein the balance is a power balance, wherein the document is a legal document setting conditions between a first entity and a second entity, wherein the first policy is a policy of the first entity, wherein the second policy is a policy of the second entity;
wherein said method further comprises:
determining an estimated relative power of the first entity and of the second entity, whereby determining that the estimated relative power of the first entity is greater than the estimated relative power of the second entity;
wherein said modifying comprises:
selecting a parameter for an intersection range between a first rule of the first policy and between a second rule of the second policy, wherein the selection of the parameter is biased to favor the first rule, whereby biasing the selection to favor an entity having a greater estimated power.

9. The method of claim 8,
wherein the first rule of the first policy comprises a first range of parameters for a condition of the document, and the second rule of the second policy comprises a second range of parameters for the condition of the document;
wherein the first range and the second range overlap at the intersection range;
wherein said selecting the parameter comprises:
identifying a highest-utility parameter in the intersection range, wherein the highest-utility parameter is a parameter having a highest utility for the first entity in the intersection range; and
selecting the highest-utility parameter.

10. The method of claim 6, wherein said modifying comprises:
performing one or more selections of parameters with respect to a first set of one or more intersection ranges between the first policy and the second policy that favors the first policy;
performing one or more selections of parameters with respect to a second set of one or more intersection ranges between the first policy and the second policy that favors the second policy; and
wherein a ratio between the first set and the second set is based on the balance.

11. The method of claim 10, wherein the balance is an overall equal balance, wherein the ratio is about 1:1.

12. The method of claim 10, wherein the balance is a random balance, wherein the ratio is determined randomly.

13. The method of claim 6, wherein an intersection range of a rule of the first policy is prioritized in an opposite order than an intersection range of a corresponding rule of the second policy.

14. The method of claim 1 comprising randomly selecting parameters for intersection ranged between first rules of the first policy and between second rules of the second policy, respectively.

15. The method of claim 1 further comprises:
determining that a first range and a second range are disjoint, wherein the first range is defined by a first rule of the first policy with respect to a condition, wherein the second range is defined by a second rule of the second policy with respect to the condition, wherein the document comprises the condition; and
providing a notification that automated resolution cannot be performed with respect to the condition.

16. The method of claim 1 comprising:
accumulating a plurality of policies of an entity, wherein the plurality of policies comprise the first policy and exclude the second policy;
analyzing the plurality of policies to determine a consistency rate of policies of the entity; and
in response to determining that the consistency rate is below a threshold, preforming a remedial action.

17. The method of claim 1 comprising:
obtaining a training set, wherein the training set comprises a sequence of policies of an entity, and a label indicating whether the entity is malicious;
training a predictor to identify a malicious entity using the training set;
obtaining a sequence of past policies of a first entity that provided the first policy;
applying the predictor to determine whether the first entity is malicious; and
in response to a determination that the first entity is malicious, performing a remedial action to prevent malicious activity of the first entity.

18. The method of claim 1 comprising processing the first policy on the document at the first edge device to determine whether or not the document complies with the first set of one or more conditions.

19. The method of claim 1 comprising processing the second policy on the document at the second edge device to determine whether or not the document complies with the second set of one or more conditions.

20. The method of claim 1, wherein said obtaining the first policy, the second policy, and the document is at a cloud server.

21. A computerized apparatus having a processor and coupled memory, the processor being adapted to perform the steps of:
obtaining a first policy from a first edge device, wherein the first policy comprises a first set of one or more rules regarding a first set of one or more conditions, respectively;
obtaining a second policy from a second edge device, wherein the second policy comprises a second set of one or more rules regarding a second set of one or more conditions, respectively;
obtaining a document comprising one or more conditions;
processing the first set of one or more rules on the document to classify each condition of the one or more conditions in the document as allowed or not allowed by the first policy;
processing the second set of one or more rules on the document to classify each condition of the one or more conditions in the document as allowed or not allowed by the second policy; and
providing an output that identifies conditions of the one or more conditions in the document that are not allowed by at least one of the first and second policies,
wherein the output is provided without disclosing a content of the first policy to the second edge device and without disclosing a content of the second policy to the first edge device.

22. A non-transitory computer readable medium retaining program instructions, which program instructions when read by a processor, cause the processor to perform a method comprising:
obtaining a first policy from a first edge device, wherein the first policy comprises a first set of one or more rules regarding a first set of one or more conditions, respectively;
obtaining a second policy from a second edge device, wherein the second policy comprises a second set of one or more rules regarding a second set of one or more conditions, respectively;
obtaining a document comprising one or more conditions;
processing the first set of one or more rules on the document to classify each condition of the one or more conditions in the document as allowed or not allowed by the first policy;
processing the second set of one or more rules on the document to classify each condition of the one or more conditions in the document as allowed or not allowed by the second policy; and
providing an output that identifies conditions of the one or more conditions in the document that are not allowed by at least one of the first and second policies,
wherein the output is provided without disclosing a content of the first policy to the second edge device and without disclosing a content of the second policy to the first edge device.
